(19) United States
(12) Patent Application Publication
(10) Pub. No.: US 2025/0316680 A1
(43) Pub. Date: Oct. 9, 2025

(54) SECONDARY BATTERY MANUFACTURING APPARATUS AND METHOD FOR PREVENTING WRINKLE OF UNCOATED PORTION

(71) Applicant: SAMSUNG SDI CO., LTD., Yongin-si (KR)

(72) Inventor: Hyunjin Lee, Yongin-si (KR)

(21) Appl. No.: 18/967,368

(22) Filed: Dec. 3, 2024

(30) Foreign Application Priority Data
Apr. 9, 2024 (KR) 10-2024-0047742

(51) Int. Cl. H01M 4/139; B05C 9/12; H01M 4/04; H01M 4/62

(52) U.S. Cl. CPC H01M 4/139; B05C 9/12; H01M 4/0404; H01M 4/624; H01M 4/626

(57) ABSTRACT

A secondary battery manufacturing apparatus includes: a coating unit configured to coat a mixture on a substrate of an electrode plate of an electrode assembly of a secondary battery such that the electrode plate has a coated portion and an uncoated portion; and an uncoated portion rigidity increasing unit configured to apply a metal layer to the uncoated portion of the electrode plate to increase a rigidity of the uncoated portion.

### CROSS-REFERENCE TO RELATED APPLICATION

The present application claims priority to and the benefit of Korean Patent Application No. 10-2024-0047742, filed on Apr. 9, 2024, in the Korean Intellectual Property Office, the entire disclosure of which is incorporated herein by reference.

### BACKGROUND

### 1. Field

Aspects of embodiments of the present disclosure relate to a secondary battery manufacturing apparatus and method for preventing wrinkle of an uncoated portion of an electrode plate.

### 2. Description of the Related Art

Different from primary batteries that are not designed to be (re) charged, secondary batteries are designed to be discharged and recharged. Generally, a secondary battery includes an electrode assembly including (or composed of) a positive electrode plate, a negative electrode plate, and a separator. The positive/negative electrode plates may be manufactured through processes, such as rolling, drying, slitting, and notching, subsequent to a process of coating an active material on a substrate. The electrode assembly is manufactured by placing the separator between the positive/negative electrode plates manufactured in this way and applying a winding method or a stack method.

The secondary battery manufacturing process includes a coating process of coating an active material slurry on one side or both sides of a metal substrate to form a positive electrode or a negative electrode. The coated electrode plate includes a coated portion at where the active material is coated and an uncoated portion at where the active material is not coated. A difference occurs in rigidity between the coated portion and the uncoated portion due to the presence or absence of the active material coated on the substrate, and thus, the uncoated portion, which is relatively weaker or less rigid than the coated portion, may wrinkle.

The above information disclosed in this Background section is for enhancement of understanding of the background of the present disclosure, and therefore, it may contain information that does not constitute related (or prior) art.

### SUMMARY

Embodiments of the present disclosure provide a secondary battery manufacturing apparatus and method that can prevent wrinkles that occur in an uncoated portion during a manufacturing process of an electrode plate.

According to an embodiment of the present disclosure, a secondary battery manufacturing apparatus includes: a coating unit configured to coat a mixture on a substrate of an electrode plate of an electrode assembly of a secondary battery such that the electrode plate has a coated portion and an uncoated portion; and an uncoated portion rigidity increasing unit configured to apply a metal layer to the uncoated portion of the electrode plate to increase a rigidity of the uncoated portion.

In some embodiments, the metal layer applied to the uncoated portion by the uncoated portion rigidity increasing unit may be a metal film attached to a surface of the uncoated portion. In some embodiments, the metal layer applied to the uncoated portion by the uncoated portion rigidity increasing unit may be a material that is applied to a surface of the uncoated portion to form a coating layer.

According to another embodiment of the present disclosure, a secondary battery manufacturing method includes: coating a mixture on a substrate of an electrode plate of an electrode assembly of a secondary battery such that the electrode plate has a coated portion and an uncoated portion; and applying a metal layer to the uncoated portion of the electrode plate to increase a rigidity of the uncoated portion.

Aspects and features of the present disclosure are not limited to those described above, and other aspects and features not specifically mentioned herein, will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings:

FIG. 1 schematically illustrates an electrode assembly of a secondary battery;

FIG. 2 schematically illustrates a pouch-type secondary battery;

FIG. 3 is a cross-sectional view of a cylindrical secondary battery;

FIG. 4 illustrates a cross-sectional view of a prismatic secondary battery;

FIG. 5 is a schematic diagram of a process of manufacturing an electrode plate of the electrode assembly illustrated in FIG. 1;

FIG. 6 illustrates a single-row coated electrode plate;

FIG. 7 illustrates a multi-row coated electrode plate;

FIG. 8 is a schematic diagram of an uncoated portion rigidity increasing unit according to an embodiment of the present disclosure;

FIG. 9 is a side view of FIG. 8;

FIG. 10 is a cross-sectional view illustrating the layered structure of a metal film;

FIG. 11 is a schematic diagram of an uncoated portion rigidity increasing unit according to another embodiment of the present disclosure;

FIG. 12 is a schematic diagram of an uncoated portion rigidity increasing unit according to an embodiment of the present disclosure;

FIG. 13 illustrates a unit for removing a metal film or a coating layer;

FIG. 14 is a view of a secondary battery module in which secondary batteries are arranged according to one or more embodiments of the present disclosure;

FIG. 15 is a view of a secondary battery pack including the secondary battery module illustrated in FIG. 14; and

FIG. 16 is a schematic view of a vehicle including the secondary battery pack illustrated in FIG. 15.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of one or more embodiments of the present disclosure and do not represent all of the aspects and features of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same.” Thus, the phrase “substantially the same” may include a case having a deviation that is considered low in the art, for example, a deviation of about 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

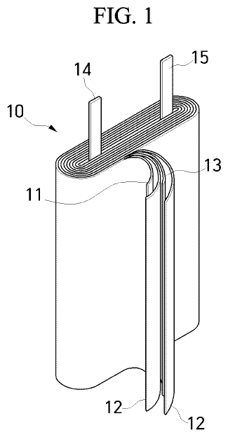

FIG. 1 shows an electrode assembly of a secondary battery.

Referring to FIG. 1, an electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to the longitudinal direction of a case. In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

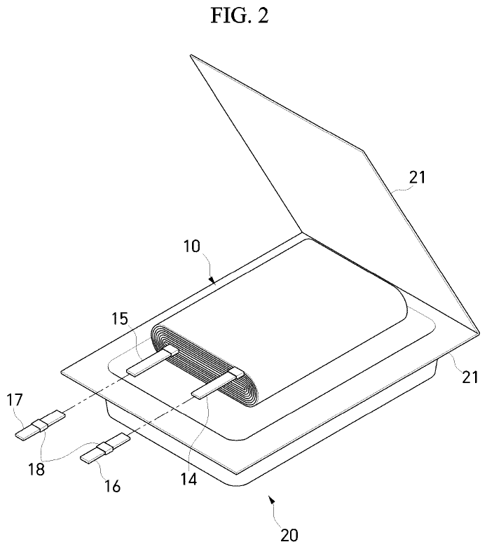

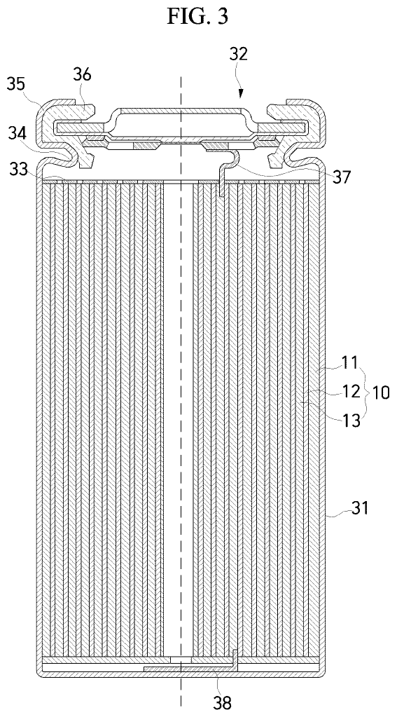

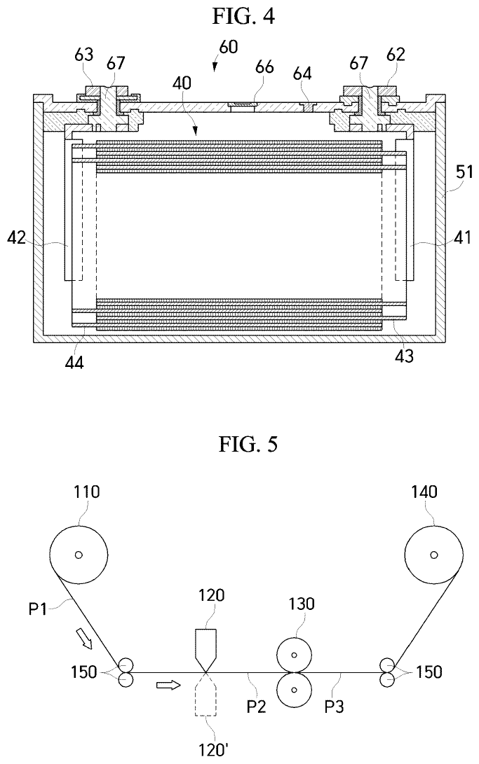

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

FIG. 2 schematically illustrates the pouch-type secondary battery.

The pouch-type secondary battery includes an electrode assembly 10 and a pouch 20 that accommodates the electrode assembly 10.

The electrode assembly 10 may be the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with (e.g., covered by) a tab film 18 for insulation from the pouch 20.

The pouch 20 may be sealed by having sealing parts 21 at the edges thereof come into contact with each other while accommodating the electrode assembly 10 therein, and the sealing may be achieved with the tab film 18 interposed between the sealing parts 21. The sealing parts 21 of the pouch 20 may each be made of a thermal fusion material that generally exhibits weak adhesion to metal. Thus, the pouch 20 may be fused together by interposing the thin film 18 between the sealing parts 21 to ensure a sufficient seal.

FIG. 3 illustrates a cylindrical secondary battery. As shown in FIG. 3, a secondary battery may include an electrode assembly 10, a case 31 accommodating the electrode assembly 10 and an electrolyte therein, a cap assembly 32 coupled to an opening in the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 32, forms an external appearance of the secondary battery. The case 31 may have a substantially cylindrical body portion and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of a gasket 36 and the cap assembly 32. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 shows an internal structure of a prismatic secondary battery.

As shown in FIG. 4, a prismatic secondary battery may include an electrode assembly 40, a first current collector 41, a first terminal 62, a second current collector 42, a second terminal 63, a case 51, and a cap assembly 60.

The electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction of the case 51. In other embodiments, the electrode assembly 40 may be a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies 40 may be stacked such that long sides of the electrode assemblies 40 are adjacent to each other and accommodated in the case 51, and the number of electrode assemblies 40 in the case 51 is not limited in the present disclosure. The first electrode plate of the electrode assembly may act as a negative electrode, and the second electrode plate may act as a positive electrode. Of course, the reverse is also possible.

In the electrode assembly 40, the first current collector 41 and the second current collector 42 may be welded and connected to the first electrode tab 43 extending from the first electrode plate and the second electrode tab 44 extending from the second electrode plate, respectively. As described above, in embodiments in which the first electrode tab 43 and the second electrode tab 44 are located at the top of the electrode assembly 40, the first and second current collectors are located at the top of the electrode assembly 40.

As illustrated in FIG. 4, the first current collector 41 and the second current collector 42 are connected to the first terminal 62 and the second terminal 63 through connection members 67, respectively. In some embodiments, the connection members 67 may each have an outer peripheral surface that is threaded and may be fastened to the first terminal 62 and the second terminal 63 by screwing. However, the present disclosure is not limited thereto. In other embodiments, the connection members 67 may be coupled to the first terminal 62 and the second terminal 63 by riveting or welding.

FIG. 5 is a schematic diagram describing a process for manufacturing an electrode plate (e.g., the first electrode plate 11 or the second electrode plate 13) of the electrode assembly 10 illustrated in FIG. 1 or the electrode assembly 40 illustrated in FIG. 4.

A supply roll 110 is a roll on which a substrate P1 for an electrode plate is wound. When an apparatus for manufacturing electrode plates according to embodiments the present disclosure is used to manufacture a positive electrode plate, the substrate P1 may be a metal foil including (or containing) aluminum (Al), for example. Alternatively, when the apparatus for manufacturing electrode plates according to embodiments of the present disclosure is used to manufacture a negative electrode plate, the substrate P1 may be a metal foil including (or containing) copper (Cu) or nickel (Ni).

A transfer roller 150 may be an idle roller that guides the substrate P1 as it is unwounded from the supply roll 110 or a drive roller that applies a pulling force to unwind the substrate P1 from the supply roll 110. FIG. 5 illustrates an embodiment including a total of four transfer rollers 150 as an example only, and the number and positions of transfer rollers may be varied.

A coating unit 120 forms a coating layer by coating the substrate P1 with a mixture of electrode materials in either slurry or powder state that is previously prepared. In some embodiments, both surfaces, namely the upper and lower surfaces, of the substrate P1 may be concurrently (or simultaneously) coated by adding a second coating unit 120′, having the same configuration as the coating unit 120 illustrated in FIG. 5, to the lower surface of the substrate P1.

When the apparatus for manufacturing electrode plates according to embodiments of the present disclosure is used to manufacture the positive electrode plate, the slurry may include (or contain) an active material containing a transition metal oxide, a binder, a volatile solvent, and the like, for example. When the apparatus is used to manufacture the negative electrode plate, the slurry may be prepared with (e.g., may include) an active material containing a transition metal oxide, a binder, a solvent, or the like.

A winding roll 140 is a roll that winds and accommodates an electrode plate P3 coated by the coating unit 120 and rolled by the press unit 130.

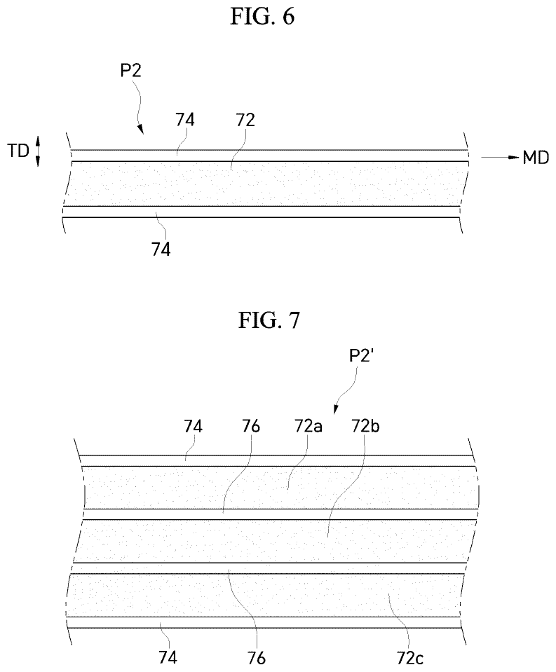

FIG. 6 illustrates the electrode plate P2 coated by the coating unit 120 shown in FIG. 5. The coated electrode plate P2 has a coated portion 72 in which an active material mixture is coated on the substrate and an uncoated portion 74 at where the substrate is not coated with the active material mixture. Because a difference occurs in substrate rigidity between the coated portion 72 and the uncoated portion 74 depending on (or due to) the presence or absence of the mixture coating, wrinkles occur in the uncoated portion having relatively weak rigidity. The occurrence of wrinkles due to such a difference in rigidity between the substrates may become more severe during subsequent processes.

The width direction of the electrode plate is referred to as a transverse direction TD, and the longitudinal direction, which is the travel direction of the electrode plate, is referred to as a machine direction MD.

The coating unit 120 shown in FIG. 5 may include a device (e.g., a multi-row coating slot die) that concurrently (or simultaneously) coats several rows of coating areas in the transverse direction TD of the substrate. FIG. 7 illustrates a multi-row electrode plate P2′ formed by such a multi-row coating device. The multi-row coated electrode plate P2′ illustrated in FIG. 7 has a first-row coated portion 72a, a second-row coated portion 72b, and a third-row coated portion 72c are arranged in the transverse direction TD with uncoated portions 76 as boundaries. As in the single-coated electrode plate shown in FIG. 6, an uncoated portion 74 exists at the outermost portion of the multi-row coated electrode plate P2′. In the multi-row coated electrode plate P2′, because the coated portion exists on both sides of the uncoated portion 76 from among the first row coated portion 72a, the second row coated portion 72b, and the third row coated portion 72c, a greater difference may occur in substrate rigidity between the coated portions 72a, 72b, and 72c and the uncoated portion 76, resulting in an increase in the possibility of wrinkles and in the amount (or degree) of wrinkles in the uncoated portion 76.

The secondary battery manufacturing apparatus, according to embodiments of the present disclosure, includes an uncoated portion rigidity increasing unit for increasing the rigidity of the uncoated portions 74 and 76 of the electrode plate formed by the electrode plate coating by additionally applying a metal layer to the uncoated portions 74 and 76, which reduces a difference in substrate rigidity between the coated portions 72, 72a, 72b, and 72c and the uncoated portions 74 and 76, thereby preventing or reducing the occurrence of wrinkles in the uncoated portions 74 and 76.

In some embodiments, the metal layer applied to the uncoated portions 74 and 76 by the uncoated portion rigidity increasing unit may be a metal film attached to the surface of the uncoated portion. By using the metal film to cover the entire width of the uncoated portions 74 and 76 or to partially cover a smaller width (e.g., a portion of the width) of the uncoated portions 74 and 76, a difference between the rigidity of the uncoated portions 74 and 76 and the rigidity of the coated portion can be reduced, thereby preventing wrinkles from occurring in the uncoated portions 74 and 76. The material of the metal film to be attached to the uncoated portions 74 and 76 is, according to some embodiments, a metal material similar to the material of the substrate of the electrode plate. For example, when the electrode plate substrate is aluminum, the metal film may also be made of aluminum, and when the electrode plate substrate is copper, the metal film may also be made of copper.

In some embodiments, the metal layer applied to the uncoated portions 74 and 76 by the uncoated portion rigidity increasing unit may be a material including metal powder (e.g., copper, aluminum, etc.) applied to the surface of the uncoated portion, an adhesive, a binder, etc. Similar to the metal film described above, the metal powder used here may be aluminum when the electrode plate substrate is aluminum and may be copper when the electrode plate substrate is copper. The adhesive may increase adhesion when the metal powder is coated on the uncoated portions 74 and 76, and the binder may increase the binding force of mixed materials.

When the metal film is attached or the metal powder is applied to the uncoated portions 74 and 76, the thickness of the uncoated portion is increased, which also reduces the electrical resistance of a corresponding portion and of the entire electrode plate.

The metal film attached to the uncoated portions 74 and 76 or the metal coating material applied thereto may be removed in subsequent processed (e.g., a process in which no or minimal wrinkles are anticipated or expected to occur in the uncoated portions) or may be left without removal.

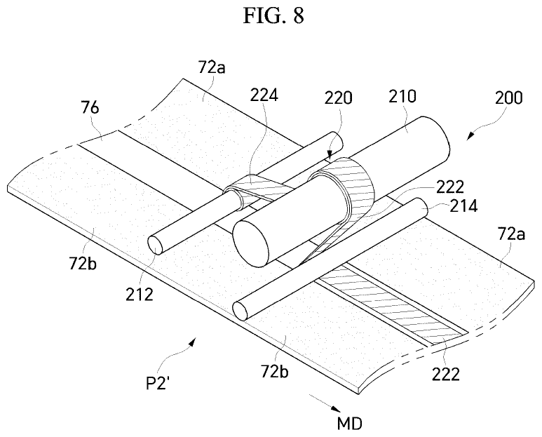

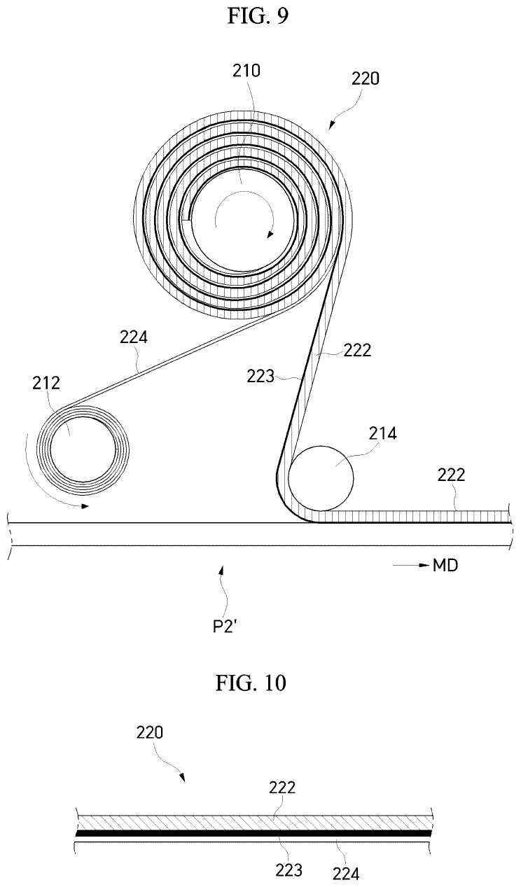

FIG. 8 is a schematic diagram of an uncoated portion rigidity increasing unit 200 according to an embodiment, and FIG. 9 is a schematic side view of FIG. 8. FIG. 10 is a cross-sectional view illustrating the layered structure of a metal film 220 applied by the uncoated portion rigidity increasing unit 200.

As illustrated in FIG. 8, the uncoated portion rigidity increasing unit 200 for attaching the metal film attaches the metal film 220 to the uncoated portion 76 of an electrode plate P2′ in the machine direction MD. The electrode plate P2′ is an electrode plate having an uncoated portion 76 between a first row coated portion 72a and a second row coated portion 72b, similar to the multi-row coated electrode plate P2′ illustrated in FIG. 7; however, this is merely an example. For example, the uncoated portion rigidity increasing unit 200 may be used with the electrode plate P2 having the uncoated portion 74 on both outer portions of the single-row coated portion 72 as illustrated in FIG. 6.

Before describing the configuration of the uncoated portion rigidity increasing unit 200, the metal film 220 will be first described.

As illustrated in FIG. 10, the metal film 220 has a layered structure including a metal layer 222, an adhesive layer 223, and a release paper 224. To attach the metal layer 222 to the uncoated portions 74 and 76, the adhesive layer 223 is applied to the metal layer 222, and the release paper 224 covers and protects the adhesive layer 223. The metal layer 222 may be made of a material similar to the electrode plate substrate as described above (e.g., an aluminum metal layer for an aluminum substrate, or a copper metal layer for a copper substrate). The thickness of the metal layer 222 may be in a range of about 3 μm to about 20 μm in the case of an aluminum substrate and may be in a range of about 3 μm to about 25 μm in the case of a copper substrate. These thicknesses may be determined in consideration of the coating thickness of the electrode plate. As the thickness of the uncoated portion is increased, electrical resistance may be reduced.

Referring back to FIGS. 8 and 9, the configuration of an embodiment of the uncoated portion rigidity increasing unit 200 will be described.

As illustrated in FIGS. 8 and 9, the uncoated portion rigidity increasing unit 200 includes: a metal film winding roll 210 wound around with the metal film 220 including the metal layer 222, the adhesive layer 223, and the release paper 224; a release paper removal roll 212 that removes the release paper 224 from the metal film 220 wound around the metal film winding roll 210; and a metal layer press roll 214 that attaches the metal layer 222, from which the release paper 224 has been removed to expose the adhesive layer 223, to the uncoated portion 76 of the electrode plate P2′ by bringing the metal layer 222 into contact with the uncoated portion 76 and pressing the metal layer 222.

As the release paper removal roll 212 rotates and peels off the release paper 224 from the metal film 220, the metal layer 222 with the exposed adhesive layer 223 comes into contact with the uncoated portion 76 of the electrode plate P2′ by the metal layer press roll 214. As the electrode plate P2′ moves in the machine direction MD, the metal layer 222 is attached to the uncoated portion 76 in the machine direction MD.

The metal film 220 may cover the entire width of the uncoated portion 76 or may partially cover a smaller width of the uncoated portion 76, thereby increasing the substrate rigidity of the uncoated portion 76 and preventing wrinkles. To prevent the metal film 220 from interfering with the coated portions 72a and 72b of the electrode plate P2′, the width of the metal film 220 may be about 50% to 70% of the width of the uncoated portion.

To maximize a contact area between the metal layer 222 and the uncoated portion 76 of the metal substrate, the adhesive layer 223 of the metal film 220 may be uniformly applied to the entire surface of the metal layer 222 or may be applied in the form of a plurality of adhesive stripes. The width of each stripe of the adhesive stripe may be in a range of about 1 mm to about 3 mm, but this may be determined by the size and material of the electrode plate P2′, the width of the uncoated portion 76, etc. Both thermosetting and thermoplastic resins may be used as materials for the adhesive layer 223, but a thermosetting resin may prevent the adhesive layer material from melting and migrating during tab welding to the uncoated portion in a subsequent process. The amount of adhesive applied to form the adhesive layer 223 may be in a range from about 0.1 g/m² to about 1.0 g/m².

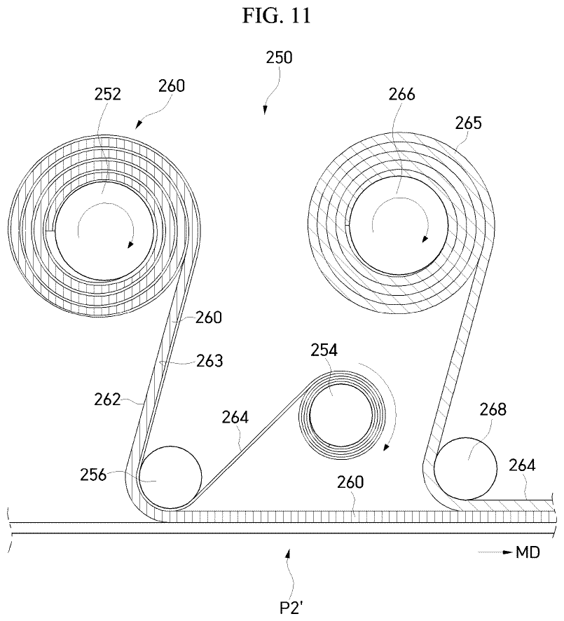

FIG. 11 is a schematic diagram of an uncoated portion rigidity increasing unit 250 according to another embodiment.

In this embodiment, a metal film 265 without an adhesive layer applied thereto, different from the embodiment illustrated in FIG. 10, is attached to the uncoated portion 76, and a separate adhesive tape 260 is used for attachment.

As illustrated in FIG. 11, the uncoated portion rigidity increasing unit 250 according to this embodiment includes: an adhesive tape winding roll 252 wound around with an adhesive tape 260 having an exposed first-side adhesive layer 262 and a second-side adhesive layer 263 applied to each surface of the adhesive tape 260 with the second-side adhesive layer 263 being covered with a release paper 264; an adhesive tape press roll 256 that attaches the first-side adhesive layer 262 of the adhesive tape 260 to the uncoated portion 76 of the electrode plate P2′ by bringing the first-side adhesive layer 262 into contact with the uncoated portion 76 and pressing the first-side adhesive layer 262; a release paper removal roll 254 that removes the release paper 264 of the adhesive tape 260 attached to the uncoated portion 76 to expose the second-side adhesive layer 263; a metal film winding roll 266 wound around with the metal film 265; and a metal film press roll 268 that attaches the metal film 265 wound around the metal film winding roll 266 to the second-side adhesive layer 263 of the adhesive tape 260 attached to the uncoated portion 76 by bringing the metal film 265 into contact with the second-side adhesive layer 263 and pressing the metal film 265.

With such a configuration, while the electrode plate P2′ is moved in the machine direction MD, the first-side adhesive layer 262 of the adhesive tape 260 unwound from the adhesive tape winding roll 252 is attached to the uncoated portion 76 of the electrode plate P2′ by the press roll 256, and the release paper 264 is peeled off by the release paper removal roll 254 to expose the second-side adhesive layer 263. Subsequently, the metal film 265 wound around the metal film winding roll 266 is unwound, is pressed by the press roll 268 and is attached to the second-side adhesive layer 263 of the adhesive tape 260.

FIG. 12 is a schematic diagram of an uncoated portion rigidity increasing unit 300 according to another embodiment.

In this embodiment, an uncoated portion rigidity increasing unit 300 may include a coating nozzle configured to form a coating layer 310 by coating a mixture of metal powder, binder material, etc., on the uncoated portion 76 of the electrode plate P2′.

The coating layer 310 may cover the entire width of the uncoated portion 76 or may be formed to have a width smaller than the width of the uncoated portion 76. To prevent the coating layer 310 from interfering with the coated portions 72a and 72b of the electrode plate P2′, the width of the coating layer 310 may be in a range of about 50% to about 70% of the width of the uncoated portion 76. The coating method may be selected from among spray, slot die, and nozzle methods, and the application amount may be in a range from about 0.5 mg/cm² to about 3 mg/cm².

The mixture for forming the coating layer 310 may include metal powder, adhesive resin, and paste (e.g., a binder, etc.).

The material of the metal powder may be copper or aluminum, as described above, but may also be selected from gold, silver, zinc, tungsten, nickel, iron, platinum, and tin. Furthermore, a conductive polymer, such as poly(p-phenylenevinylene), polyacetylene, polyaniline, polypyrrole, polythiophene, poly(p-phenylene), polyvinylidene, and polyphenylene derivative, can be used in place of or together with the metal powder.

The material of the adhesive resin can be selected from among thermosetting resin, such as epoxy, phenol, melamine, urea, unsaturated polyester, alkyd, silicon, polyurethane, polyimide resin, etc., or thermoplastic resin, such as polytetrafluoroethylene, polyethylene, polypropylene, polystyrene, vinyl chloride, vinylidene chloride, fluorine, acrylic, polyvinyl acetate, polycarbonate, acetal, polyphenylene oxide, polyester, polysulfone resin, etc. Both the thermosetting resin and the thermoplastic resin can be used, but the thermosetting resin may be more resistant to melting and migrating during tab welding to the uncoated portion in a subsequent process. The ratio of metal powder (or conductive polymer) and resin may be in a range of about 99:1 wt % to about 70:30 wt %.

The mixture may include a conductive material to control (or the adjust) the conductivity of the coating layer 310 according to the electrical characteristics of the electrode plate P2′. The conductive material can be selected from among carbon black, such as acetylene black, Ketchen black, Denka black, thermal black, channel black, furnace black, lamp black, and thermal black, a carbon-based material with a crystal structure of graphene or graphite, a conductive fiber, such as a carbon fiber and a metal fiber, and fluorinated carbon.

In the above-described embodiments, the metal film, which is attached to the uncoated portions 74 and 76, or the coating layer formed by the uncoated portion rigidity increasing unit 200, 250, and 300 may be left without being removed even after the manufacturing of the electrode plate is completed. Because a film or coating formed of (or using) a metal material similar to the metal substrate is applied to the uncoated portions 74 and 76, the film or coating may not be removed as long as it does not affect the characteristics of the electrode plate even though the film or coating is removed. However, when the film or coating interferes with the characteristics of the electrode plate in a subsequent process, it may be removed in a subsequent process (e.g., before a process in which no or minimal wrinkles are expected or anticipated to occur in the uncoated portions). The removal may be performed in any process after the coating process, but in one embodiment, is performed after the rolling process, such as during or after the notching process.

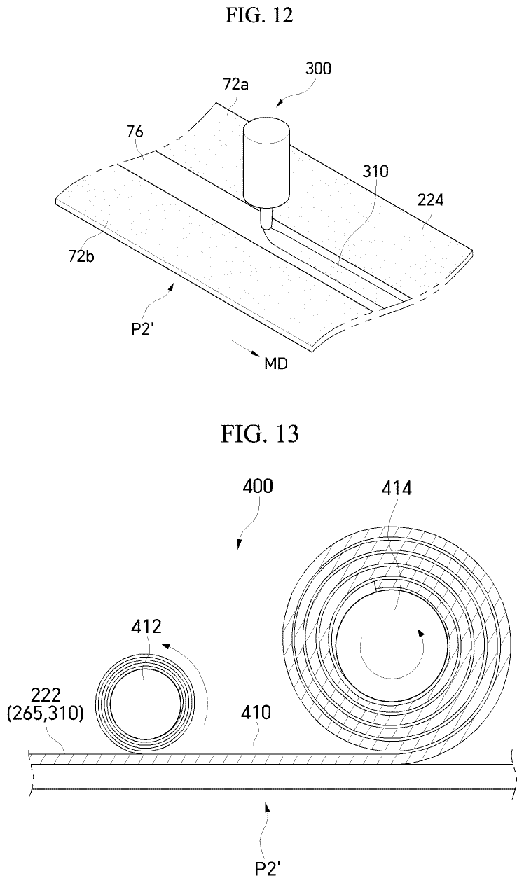

FIG. 13 illustrates a unit 400 for removing the metal film or the coating layer according to an embodiment of the present disclosure. The removal unit 400 may include: a removal tape winding roll 412 with a removal tape 410 wound therearound that is adhered to the surface of the metal layer 222, the metal film 265, or the coating layer 310 attached to the electrode plate P2′ to separate the metal layer 222, the metal film 265, or the coating layer 310 from the electrode plate P2′; and a recovery roll 414 that winds and recovers the removal tape 410 and the metal layer 222, the metal film 265, or the coating layer 310 attached to the removal tape 410 and separated from the electrode plate P2′.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≥1.8, 0≤b≥0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

1 The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

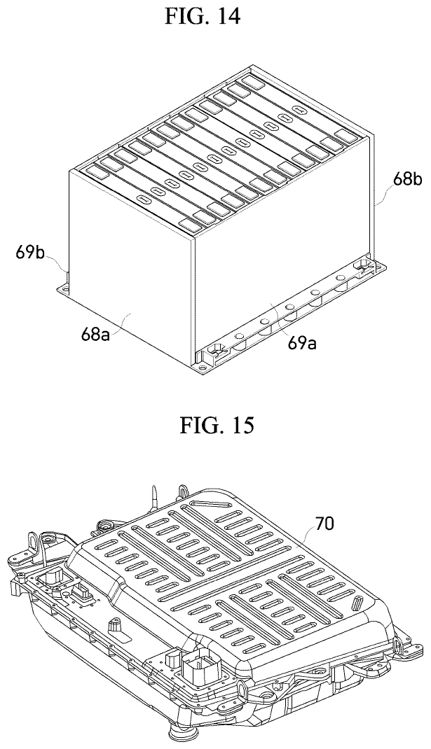

FIG. 14 is a perspective view of a secondary battery module in which prismatic secondary batteries are arranged according to embodiments of the present disclosure. With the increase in secondary battery capacity for driving electric vehicles or the like, a secondary battery module may be manufactured by arranging a plurality of secondary battery cells transversely and/or longitudinally and connecting them together. The plurality of secondary batteries may be arranged in a space defined by a pair of facing end plates 68a and 68b and a pair of facing side plates 69a and 69b. The secondary batteries may be arranged in an arrangement (direction) and number to obtain desired voltage and current specifications.

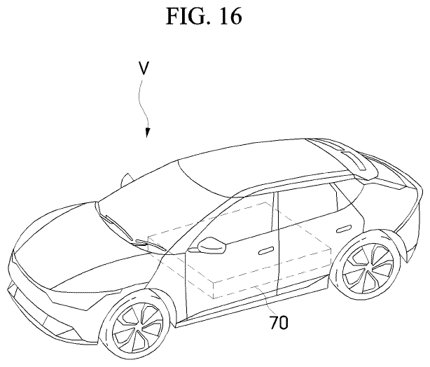

FIG. 15 is a perspective view of a battery pack 70 according to embodiments of the present disclosure. Referring to FIG. 15, the battery pack 70 may include an assembly to which individual batteries are electrically connected and a pack housing accommodating the same. In the drawings, for convenience of illustration, components including a bus bar, a cooling unit, external terminals for electrically connecting batteries, etc., are not shown.

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 16 shows a vehicle V that includes the battery pack 70 shown in FIG. 15 on the lower body thereof. The vehicle V may operate by (e.g., may be powered by) receiving power from the battery pack 70.

According to embodiments of the present disclosure, the rigidity of an uncoated portion of a multi-row coated electrode plate or a single-row coated electrode plate is increased by coating metal powder on the uncoated portion or attaching a metal film to the uncoated portion, thereby reducing a difference in substrate rigidity between a coated portion and the uncoated portion to prevent or reduce wrinkling of the electrode plate from occurring during a secondary battery manufacturing process.

In addition, a secondary battery manufactured by using the electrode plate according to embodiments of the present disclosure has increased substrate rigidity and no wrinkles, thereby preventing or mitigating breakage and fracture of the electrode plate and improving the performance, extending the lifespan, and increasing the stability of the manufactured secondary battery. Moreover, as the thickness of the uncoated portion increases, electrical resistance may be reduced.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery manufacturing apparatus comprising:
a coating unit configured to coat a mixture on a substrate of an electrode plate of an electrode assembly of a secondary battery such that the electrode plate has a coated portion and an uncoated portion; and
an uncoated portion rigidity increasing unit configured to apply a metal layer to the uncoated portion of the electrode plate to increase a rigidity of the uncoated portion.

2. The secondary battery manufacturing apparatus as claimed in claim 1, wherein the metal layer applied to the uncoated portion by the uncoated portion rigidity increasing unit comprises a metal material that is the same as a material of the electrode plate.

3. The secondary battery manufacturing apparatus as claimed in claim 1, wherein the metal layer applied to the uncoated portion by the uncoated portion rigidity increasing unit is a metal film attached to a surface of the uncoated portion.

4. The secondary battery manufacturing apparatus as claimed in claim 1, wherein the metal layer applied to the uncoated portion by the uncoated portion rigidity increasing unit is a material that is applied to a surface of the uncoated portion to form a coating layer.

5. The secondary battery manufacturing apparatus as claimed in claim 4, wherein the material that forms the coating layer comprises:
at least one of a metal powder and a conductive polymer; and
an adhesive,
wherein a ratio of the metal powder and/or the conductive polymer and the adhesive is in a range of 99:1 wt % to 70:30 wt %.

6. The secondary battery manufacturing apparatus as claimed in claim 5, wherein the material that forms the coating layer further comprises a binder.

7. The secondary battery manufacturing apparatus as claimed in claim 5, wherein the material that forms the coating layer further comprises a conductive material selected from carbon black, a carbon-based material with a crystal structure of graphene or graphite, a conductive fiber, and fluorinated carbon.

8. The secondary battery manufacturing apparatus as claimed in claim 1, wherein the uncoated portion rigidity increasing unit comprises:
a metal film winding roll with a metal film wound therearound including a metal layer, an adhesive layer applied to the metal layer, and a release paper protecting the adhesive layer;
a release paper removal roll configured to remove the release paper of the metal film wound around the metal film winding roll; and
a metal layer press roll configured to attach the metal layer from which the release paper is removed to expose the adhesive layer is exposed to the uncoated portion.

9. The secondary battery manufacturing apparatus as claimed in claim 1, wherein the uncoated portion rigidity increasing unit comprises:
an adhesive tape winding roll with an adhesive tape wound therearound comprising a first-side adhesive layer and a second-side adhesive layer covered with a release paper;
an adhesive tape press roll configured to attach the first-side adhesive layer of the adhesive tape to the uncoated portion;
a release paper removal roll configured to remove the release paper of the adhesive tape attached to the uncoated portion to expose a second-side adhesive layer;
a metal film winding roll with a metal film wound therearound; and
a metal film press roll configured to attach the metal film wound around the metal film winding roll to the second-side adhesive layer of the adhesive tape attached to the uncoated portion.

10. The secondary battery manufacturing apparatus as claimed in claim 1, wherein the uncoated portion rigidity increasing unit comprises a coating nozzle configured to form a coating layer by coating, on the uncoated portion, a coating material comprising at least one of a metal powder and a conductive polymer and an adhesive.

11. The secondary battery manufacturing apparatus as claimed in claim 1, further comprising a metal layer removal unit configured to remove the metal layer applied to the uncoated portion.

12. The secondary battery manufacturing apparatus as claimed in claim 11, wherein the metal layer removal unit comprises:
a removal tape winding roll with a removal tape wound therearound that is adhered to a surface of the metal layer applied to the uncoated portion and is separated the metal layer; and
a recovery roll configured to recover the removal tape and the separated metal layer.

13. A secondary battery manufacturing method comprising:
coating a mixture on a substrate of an electrode plate of an electrode assembly of a secondary battery such that the electrode plate has a coated portion and an uncoated portion; and
applying a metal layer to the uncoated portion of the electrode plate to increase a rigidity of the uncoated portion.

14. The secondary battery manufacturing method as claimed in claim 13, wherein the metal layer comprises a metal material that is the same as a material of the electrode plate.

15. The secondary battery manufacturing method as claimed in claim 13, wherein the metal layer is a metal film attached to a surface of the uncoated portion.

16. The secondary battery manufacturing method as claimed in claim 13, wherein the metal layer is applied to a surface of the uncoated portion to form a coating layer.

17. The secondary battery manufacturing method as claimed in claim 16, wherein the coating layer comprises:
at least one of a metal powder and a conductive polymer; and
an adhesive,
wherein a ratio of the metal powder and/or the conductive polymer and the adhesive is in a range of 99:1 wt % to 70:30 wt %.

18. The secondary battery manufacturing method as claimed in claim 16, wherein the coating layer further comprises a binder.

19. The secondary battery manufacturing method as claimed in claim 16, wherein the coating layer further comprises a conductive material selected from carbon black, a carbon-based material with a crystal structure of graphene or graphite, a conductive fiber, and fluorinated carbon.

20. The secondary battery manufacturing method as claimed in claim 13, further comprising removing the metal layer applied to the uncoated portion.
